(19) United States
(12) Patent Application Publication
(10) Pub. No.: US 2013/0282743 A1
(43) Pub. Date: Oct. 24, 2013

(54) OPTIMIZED RESOURCE ANALYTICS

(71) Applicant: INTERNATIONAL BUSINESS MACHINES CORPORATION, (US)

(72) Inventors: Chirag K. Barhate, Pune (IN); Bhooshan P. Kelkar, Bangalore (IN); Mahesh S. Paradkar, Pune (IN)

(73) Assignee: INTERNATIONAL BUSINESS MACHINES CORPORATION, Armonk, NY (US)

(21) Appl. No.: 13/873,736

(22) Filed: Apr. 30, 2013

Related U.S. Application Data
(63) Continuation of application No. 13/454,271, filed on Apr. 24, 2012.

(51) Int. Cl. G06F 17/30

(52) U.S. Cl. CPC G06F 17/30345
USPC 707/756

(57) ABSTRACT

A computer program product and system, which on determination of an entity replacement request is configured to identify an optimized entity as a replacement based on a predefined set of metadata, wherein the metadata comprises a profile associated with the entity, wherein the profile of the entity is further based on a graph, such as a graphical representation of social links, associated with the entity; and provide the optimized entity as a replacement for the entity to be replaced. Other embodiments are also disclosed.

### TECHNICAL FIELD

This disclosure relates to resource analytics, and, more particularly, human resource analytics.

### BACKGROUND

Organizations and individuals typically form teams of one or more individuals to engage in and complete a project or task. When forming these teams, there could be a number of parameters that need to be considered for the ultimate success of the project or task. For example, experience or educational qualifications of various team members can be a critical factor in execution of the project or task. Additionally, there could be a number of hard constraints such as cost or completion date targets, and soft constraints such as the perceived opportunity to generate business from a customer beyond the current project or task. With connectivity amongst individuals increasing, importantly in execution of projects, social and professional dynamics of the interactions between team members may be important to the success of a project or task, from the perspective of both hard and soft constraints.

### BRIEF SUMMARY

Accordingly, embodiments of the invention include a method, computer program product and a system where on determination of an entity replacement request; identifying an optimized entity as a replacement based on a predefined set of metadata, wherein the metadata comprises a profile associated with the entity, wherein the profile of the entity is further based on a graphical representation hereinafter also referred to as a graph, for example of a social links that a person would have, associated with the entity, or an individual and may be extended to the individual's organization or project or the like. Typically such a graph is represented as a graph that includes the interpersonal relations associated with the individual in a group situation; and providing the optimized entity as a replacement for the entity to be replaced. In a further embodiment, the profile associated with the entity is a psychometric profile, and the entity is a human resource.

In a further embodiment, the graph comprises a relationship mapping between the entity and other entities, wherein the relationship comprises roles and activities associated with the entity and other entities. In yet a further embodiment the mapping includes a lookup table, wherein the lookup table includes at least one of a structured or unstructured data.

In yet a further embodiment, on receiving a request for a replacement entity, creating a ranked list of the replacement entity. In a further embodiment, the psychometric profile includes measurement of at least of knowledge, abilities, attitudes, personality traits, educational measurement associated with the entity, and sentiment analysis of the entity. Other embodiments are also disclosed. In a further embodiment, the structured or unstructured data can include historical data, which in one form can be complied and stored in a repository.

The details of one or more implementations are set forth in the accompanying drawings and the description below. Other features and advantages will become apparent from the description, the drawings, and the claims.

### BRIEF DESCRIPTION THE SEVERAL VIEWS OF THE DRAWINGS

One or more embodiments of the present invention are described in the detailed description which follows, in reference to the noted plurality of drawings by way of non-limiting examples of exemplary embodiments of the present invention. In the figures, like reference symbols in the various drawings indicate like elements.

FIG. 1 depicts a system according to an embodiment of the present invention.

FIG. 2 is a diagrammatic view of an analytic method which may be implemented on the system of FIG. 1; and

FIG. 3 is another diagrammatic view of an analytic method which may be implemented on the system of FIG. 1.

### DETAILED DESCRIPTION

One or more embodiments disclosed within this specification generally relate to a method and a system for computing and obtaining replacement resources. More specifically, one or more embodiments can include a data relocation system (which in one embodiment is a repository or can be any data source used to compile the replacement profile for the resource) where user data is stored.

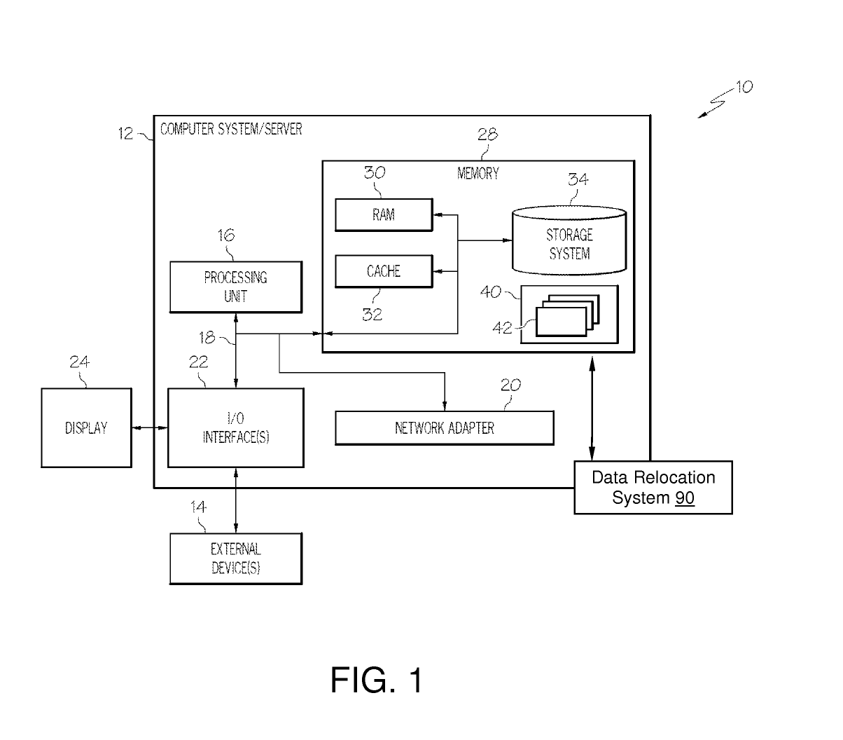

Referring now to FIG. 1, a schematic of an example of a computing system is shown. System 10 is only one example and is not intended to suggest any limitation as to the scope of use or functionality of embodiments of the invention described herein. Regardless, system 10 is capable of being implemented and/or performing any of the functionality set forth herein.

In system 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

As shown in FIG. 1, computer system/server 12 in system 10 is shown in the form of a general-purpose computing device, but may also be a special purpose computing device using programmable code to make the computer system/server 12 to perform the functions herein. The components of computer system/server 12 may include, but are not limited to, one or more processors or processing units 16, a system memory 28, and a bus 18 that couples various system components including system memory 28 to processor 16. In embodiments, the computer system/server 12 comprises or communicates with a data relocation system 90.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein, e.g., provide control, function, and operability of the data relocation system 90. For example, the program modules 42 provide control, function, and operability so that the data relocation system 90, used to store and fetch profiles or users.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

As will be appreciated by one skilled in the art, aspects of the present invention, including the data relocation system 90 and the functionality provided therein, may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

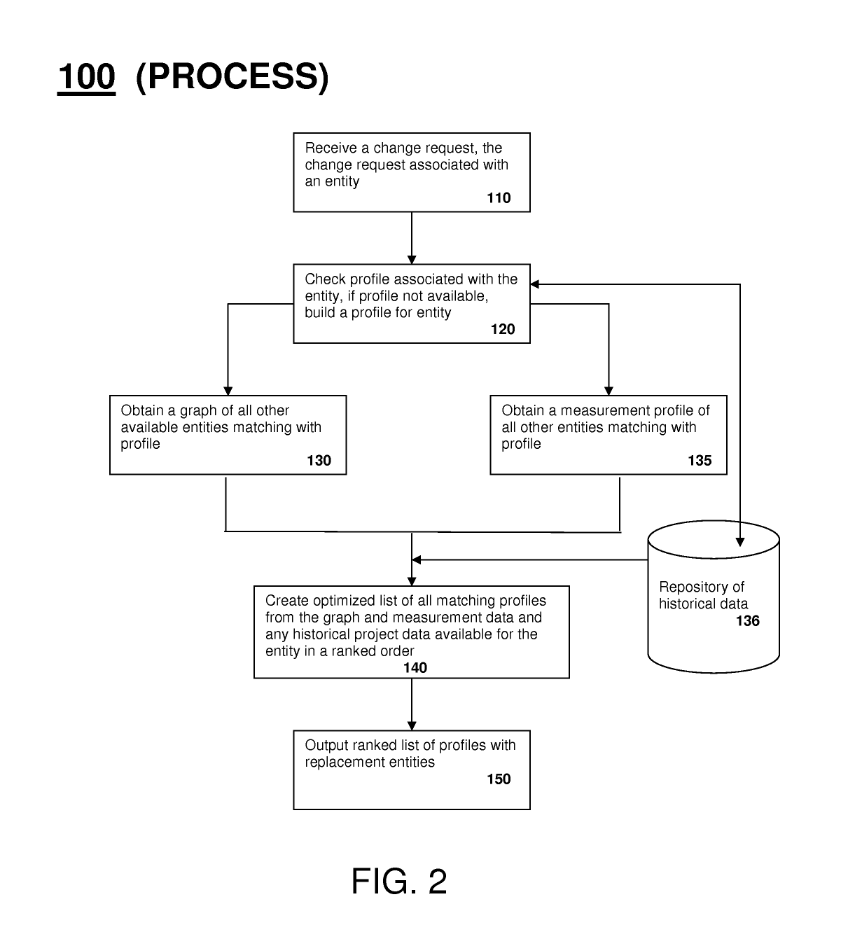

Reference is now made to FIG. 2, which illustrates a human resource analytics (HRA) method, for example method 100. As will be discussed further below, method 100 may in one embodiment include receiving 100 historical project data from the repository of historical data 136. Method 100 may also include receiving 135 psychometric data and a graph 130 (a graphical representation of social links also referred to as a sociogram) of all other entities that can be possible replacement entities, for which the change request is made. In one embodiment method 100 may also include regularly updating historical project data. Further, in a further embodiment method 100 may include receiving at least one project requirement associated with the replacement entity. Additionally, method may include determining a set of modified project requirements, including comparing the updated historical project data and the new project requirement. Method may also include determining an optimal team composition.

In step 110 a change request is received for a replacement of an entity, for example replace of a human resource in a project. In an exemplary embodiment the human resource would be a replace project manager in a project. An individual, such as the project manager whose replacement is being requested, establishes several formal and informal relationships when he/she is performing a role particular in an organization. Replacing the individual who is performing a particular role in the organization with a new individual, who will replace the existing role, will have to deal with the dynamics of the existing role, which means that the individual will have to understand all the explicit and tacit aspects of the change before he/she starts performing in the role.

In Step 120 there may be a number of individuals who can be found as a replacement entity (individual). A check is made with a repository 136 to find all profiles associated as closely as possible to the entity that needs to be replaced, and if such profiles are not available, then profiles are created for the data available in the repository. It should be noted and obvious to one skilled in the art, that for creating profiles, publically available information across the word wide web may be used as well.

In Step 130 a graph of all available entities that match with the profile of the entity that needs to be replaced is obtained. Extracting information from event logs and constructing a “graph” (sociagram) can be used to analyze interpersonal relationships in an organization. In particular, this graph can also be viewed in the context of a “Role” an individual is performing in the organization. Two factors can be considered this context to manage this changeover effectively:

1. Based on the existing graph pattern of the role/individual AND the current business need, the psychometric profile requirement for the new candidate can be derived as illustrate in step 135 and while selecting from multiple candidates having their psychometric profile, the best fit can be matched based on this requirement

2. Based on the existing graph pattern, current business need and the dynamics of relationships in the context of psychometric profiles (135), a predictive analysis of the role requirements could be presented to the selected candidate.

In step 135 therefore a measurement profile (hereinafter also referred to as a psychometric profile) of all available entities/resources/individuals matching with the profile of the requested replacement is obtained and built. Such a measurement, referred to as Psychometrics is concerned with the theory and technique of psychological measurement, which includes the measurement of knowledge, abilities, attitudes, personality traits, and educational measurement. The field is primarily concerned with the construction and validation of measurement instruments such as questionnaires, tests, and personality assessments.

In Step 140, the graph data, psychometric data and all other historical data available in the repository is taken for each candidate/entity/resource and the data is optimized for all profiles matching the replacement profile and a ranked list of replacement entities is created. In step 150 the ranked list of all the replacement profiles is output for selection of the most optimized entity as a replacement entity/resource.

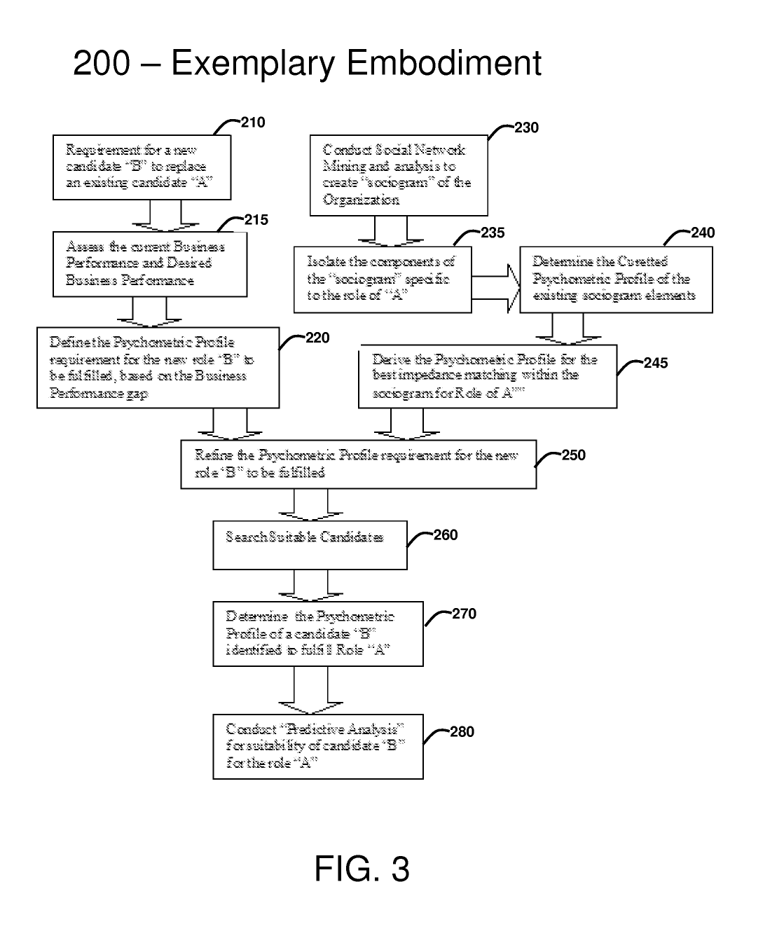

Reference is now made to FIG. 3 an exemplary embodiment which illustrates a human resource analytic (HRA) method, for example a specific method 200. It should be obvious to one skilled in the art that variation of the method can occur and such variations are covered within the scope of the embodiments of the present invention. In step 210 re requirement for a new resource (candidate) “B” is made to replace an existing candidate “A”. In step 215, the current business performance and the desired business performance are assessed. This data can be obtained from the repository in one embodiment. In step 220 a psychometric profile requirement for the new role “B” based on the business performance gap identified is made. In parallel, in step 230 social network mining and analysis is conducted to create a graph of the organization and the entity/resource. Once this is done, in step 235 the components of the graph specific to the role of “A” are isolated. In step 240 a curetted psychometric profile for the existing graph elements is determined. In step 245 a psychometric profile for the best impedance matching within the graph role for “A” is derived.

In step 250 the psychometric profile requirement for the new role “B” to be fulfilled is refined. In step 260 from the existing data of the sociogram and psychometric data and any other historical data available, a search is made for a suitable replacement candidate. In step 270 the psychometric profile of a resource “B” identified to fulfill the role of “A” is determined and in step 280 a predictive analysis for a suitable candidate “B” for the replacement of the role of “A” is conducted.

A HRA method may be a server-side method (e.g., server-side method), a client-side method (e.g., client-side method), or a hybrid server-side/client-side method (e.g., the combination of server-side method and one or more of client-side methods).

Server-side method may reside on and may be executed by server computer, which may be connected to network (e.g., the Internet or a local area network). Examples of server computer may include, but are not limited to: a personal computer, a server computer, a series of server computers, a mini computer, and/or a mainframe computer. Server computer may be a web server (or a series of servers) running a network operating system, examples of which may include but are not limited to: Microsoft® Windows Server®; Novell® Netware®; or Red Hat® Linux®, for example.

The instruction sets and subroutines of server-side method, which may be stored on storage device coupled to server computer, may be executed by one or more processors (not shown) and one or more memory architectures (not shown) incorporated into server computer. Storage device may include but is not limited to: a hard disk drive; a tape drive; an optical drive; a RAID array; a random access memory (RAM); and a read-only memory (ROM).

Server computer may execute a web server application, examples of which may include but are not limited to: Microsoft® IIS, Novell® Web Server, or Apache® Web Server, that allows for access to server computer (via network) using one or more protocols, examples of which may include but are not limited to HTTP (i.e., HyperText Transfer Protocol), SIP (i.e., session initiation protocol), and the Lotus® Sametime® VP protocol. Network may be connected to one or more secondary networks (e.g., network), examples of which may include but are not limited to: a local area network; a wide area network; or an intranet, for example.

Client-side methods may reside on and may be executed by client electronic devices (respectively), examples of which may include but are not limited to personal computer, laptop computer, a data-enabled mobile telephone, notebook computer, personal digital assistant, smart phone and a dedicated network device (not shown), for example. Client electronic devices may each be coupled to network and may each execute an operating system, examples of which may include but are not limited to Microsoft® Windows®, Microsoft Windows CE®, Red Hat® Linux®, or a custom operating system.

The instruction sets and subroutines of client-side methods which may be stored on storage devices coupled to client electronic devices, may be executed by one or more processors (not shown) and one or more memory architectures (not shown) incorporated into client electronic devices. Storage devices may include but are not limited to: hard disk drives; tape drives; optical drives; RAID arrays; random access memories (RAM); read-only memories (ROM); compact flash (CF) storage devices; secure digital (SD) storage devices; and memory stick storage devices.

One or more of client-side methods and server-side method may interface with each other via network.

Users may access server-side method directly through the device on which the client-side method (e.g., client-side methods) is executed, namely client electronic devices. Users may access server-side method directly through network and/or through secondary network. Further, server computer (i.e., the computer that executes server-side method) may be connected to network through secondary network

The various client electronic devices may be directly or indirectly coupled to network. For example, personal computer can be directly coupled to network via a hardwired network connection. Further, notebook computer can be directly coupled to network via a hardwired network connection. Laptop computer can be wirelessly coupled to network via wireless communication channel established between laptop computer and wireless access point (i.e., WAP), which is shown directly coupled to network. WAP may be, for example, an IEEE 802.11a, 802.11b, 802.11g, 802.11n, Wi-Fi, and/or Bluetooth device that is capable of establishing wireless communication channel 54 between laptop computer and WAP. Data-enabled mobile telephone can be wirelessly coupled to network via wireless communication channel established between data-enabled mobile telephone and cellular network/bridge, which can be directly coupled to network.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented method such that the instructions which execute on the computer or other programmable apparatus provide methods for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

1-9. (canceled)

10. A computer program product residing on a computer readable storage medium having a plurality of instructions stored thereon, which, when executed by a processor, cause the processor to perform operations comprising:
on determination of an entity replacement request;
identifying an optimized entity as a replacement entity based on a predefined set of metadata, wherein the metadata comprises a profile associated with the entity, wherein the profile of the entity is further based on a graph associated with the entity;
providing the optimized entity as a replacement entity.

11. The computer program product as claimed in claim 10, wherein the metadata further comprises a measurement profile associated with at least one of the entity or replacement entity.

12. The computer program product as claimed in claim 10, wherein the entity and the replacement entity is a human resource.

13. The computer program product as claimed in claim 10, wherein the graph comprises a representation of social links which further comprises a mapping between the entity and other entities, and wherein the graph comprises at least roles and activities associated between at least the entity and other entities.

14. The computer program product as claimed in claim 13, wherein the mapping is a lookup table and wherein the graph comprises at least one of a structured or unstructured data.

15. The computer program product as claimed in claim 10, further comprises creating a ranked list of the replacement entity.

16. The computer program product as claimed in claim 11, wherein the measurement profile is a psychometric profile includes measurement of at least of a knowledge, abilities, attitudes, personality traits, educational measurement and sentiment analysis of the entity.

17. A system comprising:
at least a processor and a memory, the system configured to perform:
on determination of an entity replacement request;
identifying an optimized entity as a replacement entity based on a predefined set of metadata, wherein the metadata comprises a profile associated with the entity, wherein the profile of the entity is further based on a graph associated with the entity;
providing the optimized entity as a replacement entity.

18. The system as claimed in claim 17, wherein the metadata further comprises a measurement profile associated with at least one of the entity or replacement entity.

19. The system as claimed in claim 17, wherein the entity and the replacement entity is a human resource.

20. The system as claimed in claim 17, wherein the graph comprises a representation of social links which further comprises a mapping between the entity and other entities, and wherein the graph comprises at least roles and activities associated between at least the entity and other entities.

21. The system as claimed in claim 20, wherein the mapping is a lookup table and wherein the graph comprises at least one of a structured or unstructured data.

22. The system as claimed in claim 20, further comprises creating a ranked list of the replacement entity.

23. The system as claimed in claim 18, wherein the measurement profile is a psychometric profile includes measurement of at least of a knowledge, abilities, attitudes, personality traits, educational measurement and sentiment analysis of the entity.
